(19) United States
(12) Patent Application Publication
(10) Pub. No.: US 2017/0132639 A1
(43) Pub. Date: May 11, 2017

(54) COMPUTER-EXECUTABLE METHOD AND APPARATUS FOR MANAGING CUSTOMERS WITHIN GROUP AND RECORDING MEDIUM HAVING THE METHOD RECORDED THEREON

(71) Applicants: Hyun Kyu CHOI, Seoul (KR); Dong Kyu CHOI, Seoul (KR); DELTA PDS CO., LTD., Seoul (KR)

(72) Inventors: Hyun Kyu CHOI, Seoul (KR); Dong Kyu CHOI, Seoul (KR); Jae Ho CHOI, Seoul (KR)

(73) Assignees: DELTA PDS CO., LTD., Seoul (KR); Hyun Kyu CHOI, Seoul (KR); Dong Kyu CHOI, Seoul (KR)

(21) Appl. No.: 15/347,324

(22) Filed: Nov. 9, 2016

(30) Foreign Application Priority Data
Nov. 9, 2015 (KR) 10-2015-0156464

(51) Int. Cl. G06Q 30/00; G06Q 40/04

(52) U.S. Cl. CPC G06Q 30/016; G06Q 40/04

(57) ABSTRACT

Disclosed herein is a computer-executable method for managing customers within a group, which is performed by a customer management server connected to at least two terminals. The method includes creating a transaction group in which a seller and a purchaser participate and a commodity or service is traded through a group point dependent on a group, providing the purchaser with an evaluation participation opportunity by providing the purchaser with an evaluation point when the purchase of the commodity or service is completed, receiving evaluation for the commodity or service from the purchaser and requesting an evaluation response according to the evaluation from the seller, and returning the evaluation point to the seller when the evaluation response is received and providing the purchaser with a group point according to the evaluation under the control of the seller.

### CROSS REFERENCE TO PRIOR APPLICATION

This application claims priority to Korean Patent Application No. 10-2015-0156464 (filed on Nov. 9, 2015), which is hereby incorporated by reference in its entirety.

### BACKGROUND

The present invention relates to a technology for managing customers within a group and, more particularly, to a method and apparatus for managing customers within a group, which is capable of managing a customer who has purchased a commodity or service by providing a method for evaluating commodity or service transactions performed within a specific group, and a recording medium on which the method has been recorded.

An Internet messenger corresponds to an application for delivering messages including text or graphics between users, and may be implemented to include a chatting room in which a plurality of users participate. For example, an Internet messenger may include a mobile messenger performed in a mobile environment (e.g., a portable phone), and may include KakaoTalk, Line, WeChat, and Facebook messengers, for example.

In order to support the delivery of a user's intention to the other party through a message, an Internet messenger may notify the user whether the other party has checked the message and whether the other party has participated in a chatting room.

An Internet community service application corresponds to an application through which pieces of information can be exchanged between community members using the Internet as a medium, and may be implemented as a community in which a plurality of users participate. For example, an Internet community service application may include a mobile community service application performed in a mobile environment (e.g., a portable phone), and may include Band, for example.

Korean Patent Application Publication No. 10-2002-0004459 discloses a consultation service system and service method over a network. In accordance with this technology, a consultation service method over a network is a consultation service method using one or more customer terminals and a consultation service system configured to have the one or more consultant terminals physically connected thereto over a network and to allow a consultant to consult about a matter requested by a customer over the network. The consultation service method includes a first step of receiving, by a customer, basic information through cyber document and establishing a customer management plan; a second step of receiving continuous information from the customer based on a management plan for the customer and performing customer management, and a third step of selecting a customer who belongs to one or more customers and has a problem so that the customer having a problem automatically consults with the consultant.

### PRIOR ART DOCUMENT

### Patent Document

Korean Patent Application Publication No. 10-2002-0004459

### SUMMARY

An embodiment of the present invention is directed to the provision of a method for managing customers within a group, which is capable of providing a method for evaluating commodity or service transactions performed within a specific group.

An embodiment of the present invention is directed to the provision of a method for managing customers within a group, which is capable of managing a complaint of a purchaser regarding the transactions of a commodity or service based on the evaluation message of the purchaser.

An embodiment of the present invention is directed to the provision of a method for managing customers within a group, which is capable of obtaining evaluation points in response to the evaluation message of a purchaser by providing an evaluation message including the corresponding evaluation points.

An embodiment of the present invention is directed to the provision of a method for managing customers within a group, which is capable of efficiently handling the evaluation or complaint of a purchaser for transactions by providing a problem message associated with the evaluation message of the purchaser.

In some embodiments, a computer-executable method for managing customers within a group includes the steps of (a) creating a transaction group in which a seller and a purchaser participate and a commodity or service is traded through a group point dependent on a group, (b) providing the purchaser with an evaluation participation opportunity by providing the purchaser with an evaluation point when the purchase of the commodity or service is completed, (c) receiving evaluation for the commodity or service from the purchaser and requesting an evaluation response according to the evaluation from the seller, and (d) returning the evaluation point to the seller when the evaluation response is received and providing the purchaser with a group point according to the evaluation under the control of the seller.

In an embodiment, the step (a) may include generating a subgroup in which the purchaser is managed.

In an embodiment, the step (a) may further include creating a first subgroup and a second subgroup, receiving evaluation for the commodity or service from the purchaser through the first subgroup, and receiving a problem posed in association with the evaluation from the seller through the second subgroup. In an embodiment, the step (a) may further include receiving an evaluation message including an evaluation point provided by the seller from the seller through the first subgroup and receiving a problem message including a problem point through the second subgroup. In another embodiment, the step (a) may further include receiving a setting request for a group point or subgroup point dependent on the subgroup and setting an exchange ratio of the subgroup point and the group point.

In an embodiment, the step (a) may include receiving a transaction request associated with the transactions of the commodity or service from the seller.

In an embodiment, the step (d) may include providing the problem point included in the problem message to a group participant who has responded to the posed problem when a response to the posed problem is received. In another embodiment, the step (d) may further include providing the problem point to the group participant who has responded to the posed problem on condition that a solution response regarding the evaluation message is received from the purchaser.

In an embodiment, the step (b) may include requesting the purchaser to participate in the evaluation of the commodity or service and recovering the evaluation point provided to the purchaser if the evaluation of the purchaser is not received for a predetermined period.

In an embodiment, the step (a) may include creating a group or subgroup including at least one group participant and setting whether the group or subgroup is to be public or not in order for another user to be capable of participating in the group or subgroup.

In some embodiments, a customer management server includes a processor and memory. The processor (a) creates a transaction group to which a seller and a purchaser participate and in which a commodity or service is traded through a group point dependent on a group, (b) provides the purchaser with an evaluation participation opportunity by providing the purchaser with an evaluation point when the purchase of the commodity or service is completed, (c) receives evaluation for the commodity or service from the purchaser and requesting an evaluation response according to the evaluation from the seller, and (d) returns the evaluation point to the seller when the evaluation response is received and providing the purchaser with a group point according to the evaluation under the control of the seller.

In an embodiment, in the process (a), the processor may create a first subgroup in which the purchaser is managed and a second subgroup, may receive evaluation for the commodity or service from the purchaser through the first subgroup, and may receive a problem posed in association with the evaluation from the seller through the second subgroup.

In an embodiment, in the process (a), the processor may receive an evaluation message including an evaluation point provided by the seller from the seller through the first subgroup and may receive a problem message including a problem point through the second subgroup.

In an embodiment, in the process (d), the processor may provide the problem point included in the problem message to a group participant who has responded to the posed problem when a response to the posed problem is received.

In some embodiments, there is provided a computer-readable recording medium on which a program for executing a method for managing customers within a group on a computer is recorded. The method includes functions for creating a transaction group in which a seller and a purchaser participate and a commodity or service is traded through a group point dependent on a group, providing the purchaser with an evaluation participation opportunity by providing the purchaser with an evaluation point when the purchase of the commodity or service is completed, receiving evaluation for the commodity or service from the purchaser and requesting an evaluation response according to the evaluation from the seller, and returning the evaluation point to the seller when the evaluation response is received and providing the purchaser with a group point according to the evaluation under the control of the seller.

### BRIEF DESCRIPTION OF THE DRAWINGS

FIG. 1 is a diagram illustrating a system for managing customers within a group according to an embodiment of the present invention.

FIG. 2 is a block diagram illustrating a customer management server of FIG. 1.

FIGS. 3A-3C are visualized diagrams illustrating a process of creating a group and a subgroup.

FIGS. 4A and 4B are visualized diagrams illustrating that an exchange ratio of group points in the group and subgroup of FIGS. 3A-3C is set.

FIGS. 5A-5D are diagrams illustrating the present situations of a group point and group safe in the group or subgroup of FIGS. 3A-3C.

FIGS. 6A and 6B are diagrams illustrating a process of trading commodities within a group and a process of providing an evaluation point.

FIG. 7 is a visualized diagram illustrating the evaluation message of a purchaser and a message thread associated with the evaluation message.

FIG. 8 is a visualized diagram illustrating the problem message of a seller and a message thread associated with the problem message.

FIGS. 9A and 9B are visualized diagrams illustrating the results of the settlement of the problem point included in the problem message and the evaluation point included in the evaluation message.

FIG. 10 is a flowchart illustrating a procedure for managing customers within a group, which is performed by a customer management server of FIG. 2.

### DETAILED DESCRIPTION

A description of the present invention is merely an embodiment for a structural and/or functional description. The scope of the present invention should not be construed as being limited to embodiments described in the context. That is, the embodiments may be modified in various forms, and the scope of the present invention should be construed as including equivalents which may realize the technical spirit. Furthermore, an object or effect proposed in the present invention does not mean that a specific embodiment should include all of objects or effects or should include a corresponding effect, and thus the scope of the present invention should not be understood to be restricted thereby.

The meaning of terms described in this application should be construed as follows.

The terms, such as the “first” and the “second”, are used to distinguish one element from the other element, and the scope of the present invention should not be restricted by the terms. For example, a first element may be named a second element. Likewise, a second element may be named a first element.

When it is said that one element is described as being “connected” to the other element, the one element may be directly connected to the other element, but it should be understood that a third element may be interposed between the two elements. In contrast, when it is described that one element is described as being “directly connected” to the other element, it should be understood that a third element is not interposed between the two elements. Meanwhile, the same principle applies to other expressions, such as “between ˜” and “just between ˜” or “adjacent to ˜” and “adjacent just to ˜”, which describe a relation between elements.

An expression of the singular number should be understood to include plural expressions, unless clearly expressed otherwise in the context. The terms, such as “include” or “have”, should be understood to indicate the existence of a set characteristic, number, step, operation, element, part, or a combination of them and not to exclude the existence of one or more other characteristics, numbers, steps, operations, elements, parts, or a combination of them or a possibility of the addition of them.

In each of steps, symbols (e.g., a, b, and c) are used for convenience of a description, and the symbols do not describe order of the steps. The steps may be performed in order different from order described in the context unless specific order is clearly described in the context. That is, the steps may be performed according to described order, may be performed substantially at the same time, or may be performed in reverse order.

The present invention may be implemented in a computer-readable recording medium in the form of computer-readable code. The computer-readable recording medium includes all types of recording devices in which data readable by a computer system is stored. The computer-readable recording medium may include ROM, RAM, CD-ROM, magnetic tapes, floppy disks, and optical data storages, for example. Furthermore, the computer-readable recording medium includes one implemented in the form of carrier waves (e.g., transmission through the Internet). Furthermore, the computer-readable recording medium may be distributed to computer systems connected over a network, and the computer-readable code may be stored and executed in the computer systems in a distributed manner.

All the terms used herein, including technical or scientific terms, have the same meanings as those that are typically understood by those skilled in the art, unless otherwise defined. Terms, such as ones defined in common dictionaries, should be construed as having the same meanings as those in the context of related technology and should not be construed as having ideal or excessively formal meanings, unless clearly defined in the specification.

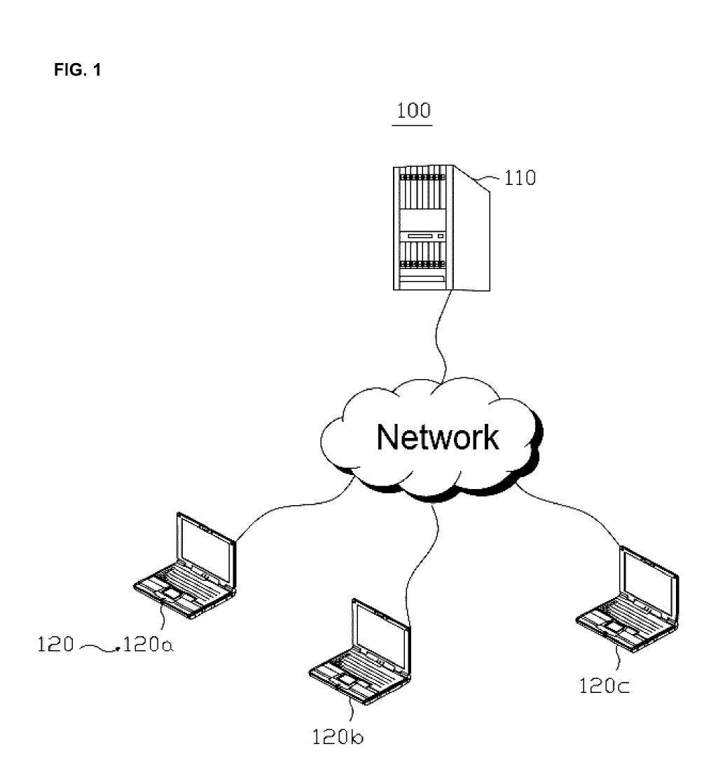

FIG. 1 is a diagram illustrating a system for managing customers within a group according to an embodiment of the present invention.

Referring to FIG. 1, the customer management system 100 includes a customer management server 110 and a user terminal 120, which may be connected over a network.

The customer management server 110 may be connected to the user terminal 120, and may manage a message thread generated by grouping evaluation messages and problem messages in a message dialogue participation user group. In an embodiment, the message thread may be implemented in the form of a chatting room of an Internet messenger. In another embodiment, the message thread may be implemented through the posts of an online bulletin board. For example, the customer management server 110 may manage a user group A, a user group B, and a user group C. The user group A may include users a1 and a2. The user group B may include users b1, b2, and b3. The user group C may include users c1, c2, c3, and c4. The customer management server 110 may generate a message thread for each of the user groups A, B, and C and manage the user groups A, B, and C.

The user terminal 120 may correspond to a computing device connected to the customer management server 110, and may be implemented using a desktop, a notebook, a tablet PC or a smart phone, for example. In an embodiment, the first user terminal 120a may correspond to a mobile terminal and may be connected the customer management server 110 through cellular communication or Wi-Fi communication. In another embodiment, the second user terminal 120b may correspond to a desktop and may be connected to the customer management server 110 through the Internet.

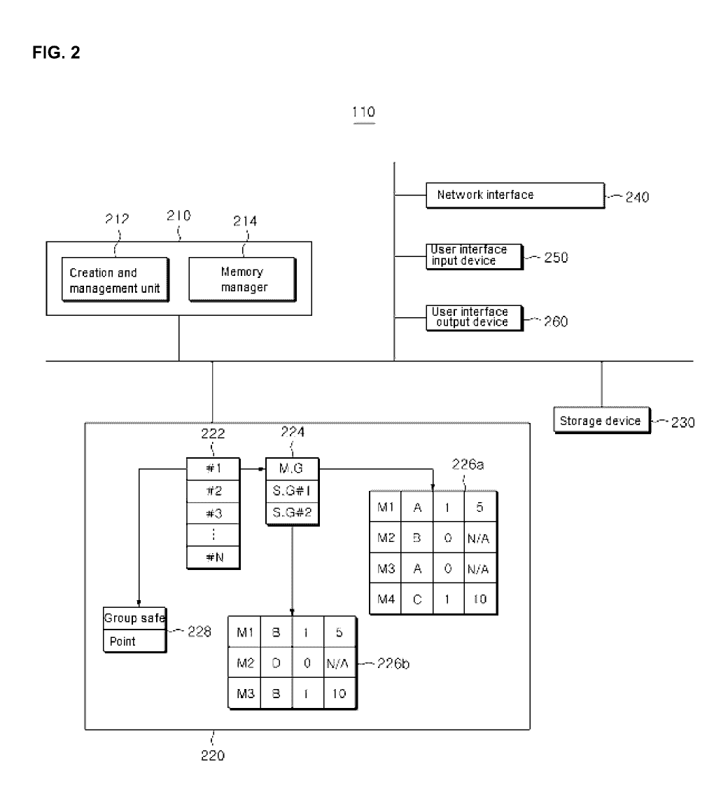

FIG. 2 is a block diagram illustrating the customer management server of FIG. 1.

Referring to FIG. 2, the customer management server 110 includes a processor 210, memory 220, a storage device 230, a network interface 240, a user interface input device 250, and a user interface output device 260.

The processor 210 includes a group creation and management unit 212 and a memory manager 214. The group creation and management unit 212 executes a group creation procedure for creating a group which trades commodities or services through a group point, an intra-group transaction procedure for relaying transactions between group participants, and a management procedure for group participants. The memory manager 214 manages memory regions 222 to 228 in the memory 220 read or written by the group creation and management unit 212.

The memory 220 includes a group map 222, a group region 224, a message map 226, and a group-common region 228. The memory regions 222 to 228 may be implemented using volatile or nonvolatile memory.

The group map 222 corresponds to the map of groups stored in the customer management server 110 and includes the position of a stored group and the storage position of common data used in a group. For example, if the number of groups now stored in the customer management server 110 corresponds to N (N is a natural number) [symbol] , the group map 222 may include position pointers indicative of the storage positions of the first group to the N-th group and the storage positions of first common data to N-th common data. In this case, the common data may correspond to data that is associated with a group and managed in common.

The group region 224 may be accessed through the group map 222, and corresponds to the space in which a transaction message associated with the transactions of a commodity or service, an evaluation message associated with evaluation or a complaint for the transactions of a commodity or service, and a problem message associated with an evaluation message, for solving a problem that may occur in the transactions of a commodity or service are stored. In an embodiment, the transaction message may correspond to a description of a message sender, a message dispatch time, and transaction contents (e.g., including a transaction commodity or service, a description of the commodity or service, and a wanted transaction group point). The evaluation message may correspond to a message sender, a message dispatch time, and evaluation contents (e.g., including a transaction commodity or service, evaluation for a commodity or service, a complaint of a commodity or service, and an evaluation point). The problem message may correspond to a message for posing a problem in order to incorporate or improve evaluation contents included in an evaluation message. The problem message may include a message sender, a message dispatch time, and the contents of a posed problem (e.g., instructions for solving a complaint of an evaluation message sender and a problem point).

In an embodiment, the group region 224 may be created for each group. More specifically, the customer management server 110 may create a new group (e.g., an online bulletin board) and perform the update of the group map 222 and the creation of the group region 224 in response to a request from a user. For example, the customer management server 110 may receive the opening request of a new group from a user A by requesting users B and C to participate in the new group, may create the group region 224 in response to the opening of the new group, and may update the group map 222 indicative of a corresponding position.

In another embodiment, the group region 224 may include a main group region in which the transaction message of a commodity or service is stored and a subgroup region in which an evaluation message or problem message is stored. For example, the group region 224 may include a main group M.G in which transaction messages between participants of a first group #1 are stored with respect to the first group #1 stored in the customer management server 110, a first subgroup S.G#1 in which the evaluation messages of transaction participants are stored, and a second subgroup S.G#2 in which problem messages associated with the evaluation messages of transaction participants are stored.

The message map 226 may correspond to a map regarding messages (e.g., including a transaction message, an evaluation message, and a problem message) stored in the group region 224, and may be created in a process of creating a message. The message map 226 includes the storage position of a message in the group region 224, a message sender, a message dispatch time, transaction contents (e.g., including a transaction commodity or service, a description of a commodity or service, a wanted transaction group point, and a transaction history), evaluation contents (e.g., including a transaction commodity or service, evaluation for a commodity or service, a complaint of a commodity or service, and an evaluation point), problem contents (e.g., including instructions for solving a complaint of an evaluation message sender and a problem point), and the status quo (e.g., including a transaction progress, a transaction cancellation, transaction completion, evaluation progress, evaluation cancellation, and evaluation completion).

In an embodiment, an evaluation message map 226a may correspond to a map regarding an evaluation message stored in the first subgroup S.G#1, and a problem message map 226b may correspond to a map regarding a problem message stored in the second subgroup S.G#2. For example, the evaluation message map 226a corresponds to the map of messages from a first message M1 to a fourth message M4. In FIG. 2, the first column of the evaluation message map 226a may correspond to the indications of the four messages M1-M4 stored in the first subgroup region S.G#1. The second column of the evaluation message map 226a may correspond to the writers of the respective messages. The third column of the evaluation message map 226a may correspond to the types of respective messages (e.g., an evaluation message may correspond to 1 and a common message other than an evaluation message may correspond to 0). The fourth column of the evaluation message map 226a may correspond to evaluation point included in a message. Likewise, the first column of the evaluation message map 226b may correspond to three messages M1-M3 stored in the second subgroup region S.G#2. The second column of the evaluation message map 226b may correspond to the writers of the respective messages. The third column of the evaluation message map 226b may correspond to the types of respective messages (e.g., a problem message may correspond to 1 and a common message other than a problem message may correspond to 0). The fourth column of the evaluation message map 226b may correspond to a problem point included in a message.

The group-common region 228 includes common data that is in common managed between group participants (i.e., users who have participated in a group). In an embodiment, the common data may correspond to group safe data and group point data. In this case, the group point data includes the present possession situation of a group point used in transactions within a group by a group participant. The group point may be set for each group. Furthermore, the group point may be differently set for each main group and subgroup of a group. For example, a group point used in the main group M.G of the first group #1 may be set as “ball”, a group point used in the first subgroup S.G#1 of the first group #1 may be set as “can”, and a group point used in the second subgroup S.G#1 of the first group #1 may be set as “prize.”

The group safe data may be managed for each group. The group safe data may be used to exchange group points used in a corresponding group (e.g., it may mean the exchange of the group point “can” used in the first subgroup S.G#1 and the group point “prize” used in the second subgroup S.G#1) or may be used to deposit actual money so as to exchange group points in transaction environment between group participants or may used to withdraw actual money by exchanging group points owned by corresponding group participant for the actual money in response to a payment request from a specific group participant. In an embodiment, the group safe data may be used to track the present depositing and withdraw situation of actual money. The group-common region 228 may be created in a process of creating a group.

The storage device 230 may be implemented using non-volatile memory, such as a solid state disk (SSD) or hard disk drive (HDD), and is used to store data for the customer management server 110.

The network interface 240 may include an environment for a connection with the customer management server 110 over a network, and may include an adapter for local area network (LAN) communication, for example.

The user interface input device 250 includes an environment for receiving user input, and may include an adapter, such as a mouse, a trackball, a touch pad, a graphic tablet, a scanner, a touch screen, a keyboard or a pointing device. The user interface output device 260 includes an environment for outputting specific information (e.g., a message thread) to a user, and may include an adapter, such as a monitor or a touch screen. In an embodiment, the user interface input device 250 and the user interface output device 260 may be connected through a remote connection.

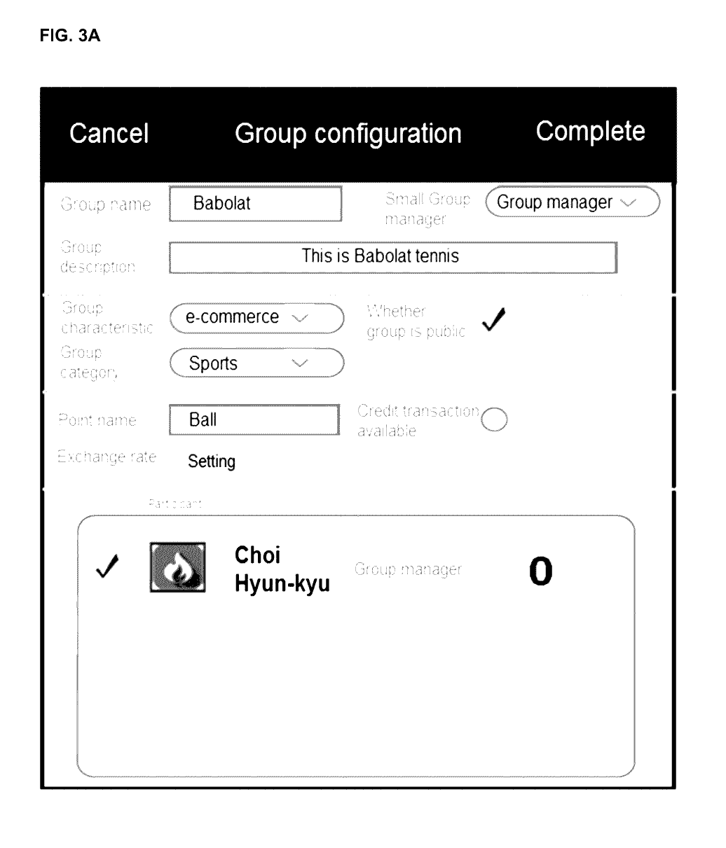

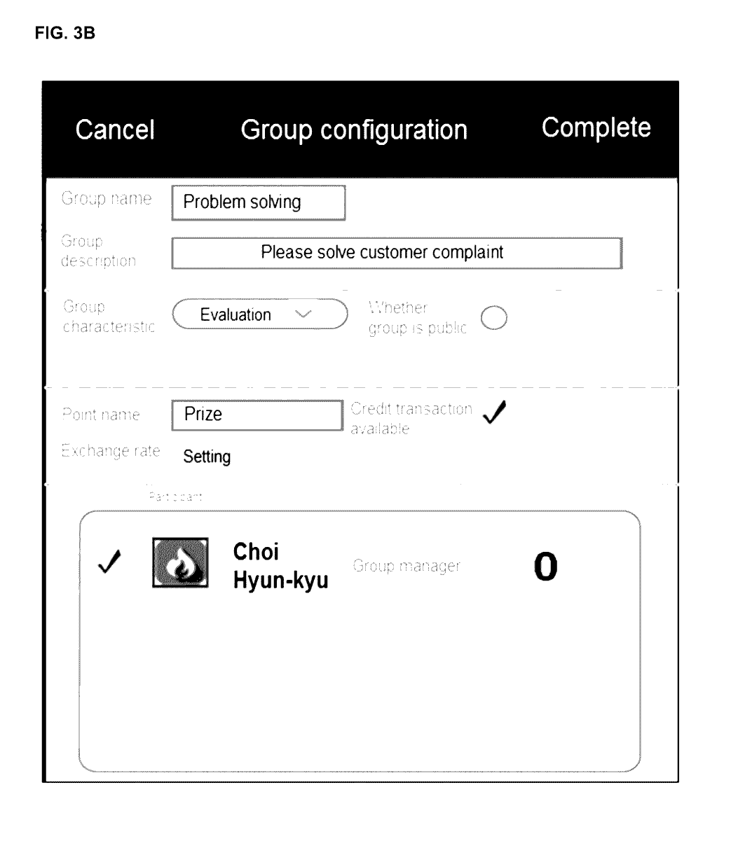

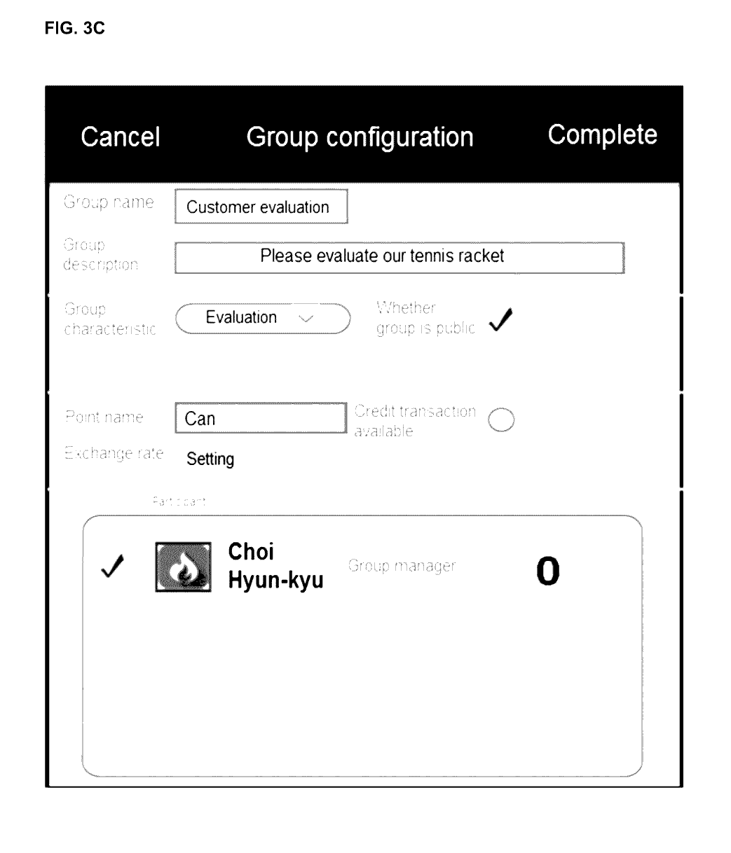

FIGS. 3A-3C are visualized diagrams illustrating a process of creating a group and a subgroup.

First, FIG. 3A is a visualized diagram illustrating a process of creating a main group in which transaction messages for selling tennis goods are stored.

The customer management server 110 may create a new group in response to a group creation request from the user terminal 120. The customer management server 110 may determine a group name (e.g., Babolat), a group manager (e.g., Choi Hyun-kyu), a group description (e.g., this is Babolat tennis), a group characteristic (e-commerce), a group category, a group participant, whether a group will be public or not, a group point name (“ball”), an exchange ratio (e.g., the foreign exchange rate) of a group point and actual money, and whether credit transactions are possible in response to a determination of a group opener, and may create a group. In this case, the group point may correspond to a property which may be used for commodity transactions or the exchange of group points within a group by group participants. The customer management server 110 may manage a transaction procedure for tennis goods between group participants through the main group of FIG. 3A.

The customer management server 110 may receive configuration information about a corresponding group along with a group creation request. That is, the customer management server 110 may provide a group configuration interface in order to create a group. The group configuration interface may include a group name, a small group manager, a group description, a group characteristic, a group category, whether a group will be public or not, a group point name, an exchange ratio of a group point and actual money, whether credit transactions are possible, and a group participant.

The group name and the group description include the name and description of a group initially defined by a group opener (e.g., a user terminal 120a), and may be subsequently changed by a group participant. The small group manager includes the subject of the small group manager which may create and manage a separate small group within a group. One of a group manager and a group member may be selected as the subject of the small group manager. For example, if a group manager is selected as a small group manager, only the small group manager may create and manage a small group. If a group member is selected as a small group manager, all of group participants within a corresponding group may create and manage a small group.

The group characteristic and the group category include a characteristic of a group and a category (e.g., the interested area of a group) to which a corresponding group belongs, which are initially defined by a group opener. Whether a group will be public or not indicates whether a group may be public to another user other than a corresponding group participant and whether another user may participate in a corresponding group. That is, whether a group will be public or not indicates whether an outside user can view and participate in a corresponding group.

The group point name includes the name of a group point initially defined by a group opener. The group point may correspond to a property which may be used for transactions within a group by group participants. For example, in the group of FIG. 3A, a group point may be indicated by “ball.”

The exchange ratio (e.g., indicated by “the foreign exchange rate” in FIGS. 3A-3C) of a group point and actual money corresponds to an exchange ratio of a group point and actual money or an exchange ratio between group points, which is initially defined by a group opener. Each exchange ratio may be set for at least one type of actual money or different group point.

Whether credit transactions are possible indicates whether a group participant can perform transactions with another group participant although he or she has not owned a group point. That is, whether credit transactions are possible may permit a group participant to own a minus group point if he or she has not owned a sufficient group point.

The group participant indicates users (e.g., Choi Hyun-kyu, Seo Hyeon-dong, and Kim Min-jae) who have joined a corresponding group. The group participant may be initially determined by a group manager (e.g., Choi Hyun-kyu) and may be subsequently changed by a group participant 420.

FIG. 3B shows a group configuration interface for creating the first subgroup of the main group in FIG. 3A. FIG. 3C shows a group configuration interface for creating the second subgroup of the main group in FIG. 3A. The group point of the first subgroup may be indicated by “can”, and the group point of the second subgroup may be indicated by “prize.”

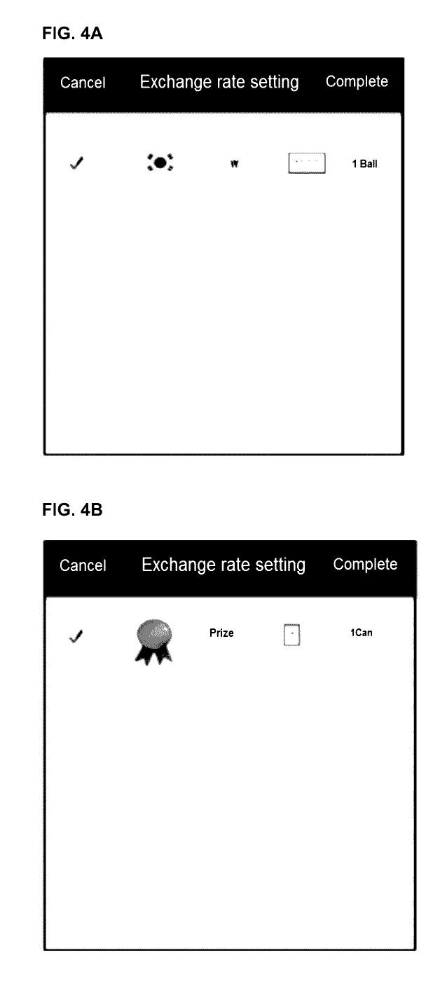

FIGS. 4A and 4B are visualized diagrams illustrating that an exchange ratio of group points in the group and subgroup of FIGS. 3A-3C is set.

The customer management server 110 may provide an exchange ratio setting interface in which an exchange ratio of group points or an exchange ratio of a group point and actual money is set. The exchange ratio setting interface includes a group point selection button by which an exchange ratio may be set or a money selection button by which actual money may be selected and an exchange ratio.

The customer management server 110 may receive another group point to be exchanged with the group point of a corresponding group or small group through the group point selection button or may receive at least one type of actual money (e.g., the Korean won, the Japanese yen, the U.S. dollars, the Chinese yuan or the European euro) for which an exchange ratio will be set through the money selection button. After the group point or actual money is selected, the customer management server 110 may receive an exchange ratio from a group opener. For example, in FIG. 4A, the group point 1 “ball” of the main group may be exchanged with the Korean “won”, and the 1 “ball” may correspond to 1000 Korean won. Likewise, in FIG. 4B, the group point 1 “prize” of the first subgroup may be exchanged with the group point “can” of the second subgroup, and the 1 “prize” may correspond to 1 can.

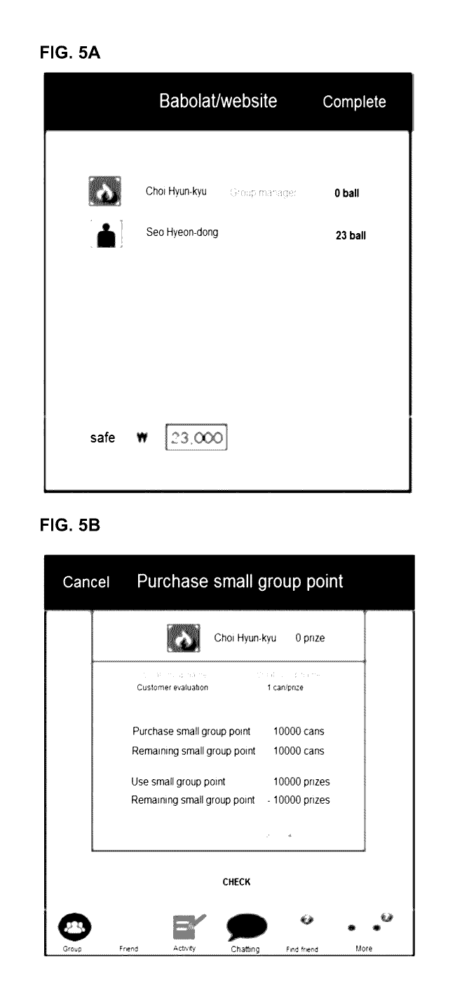

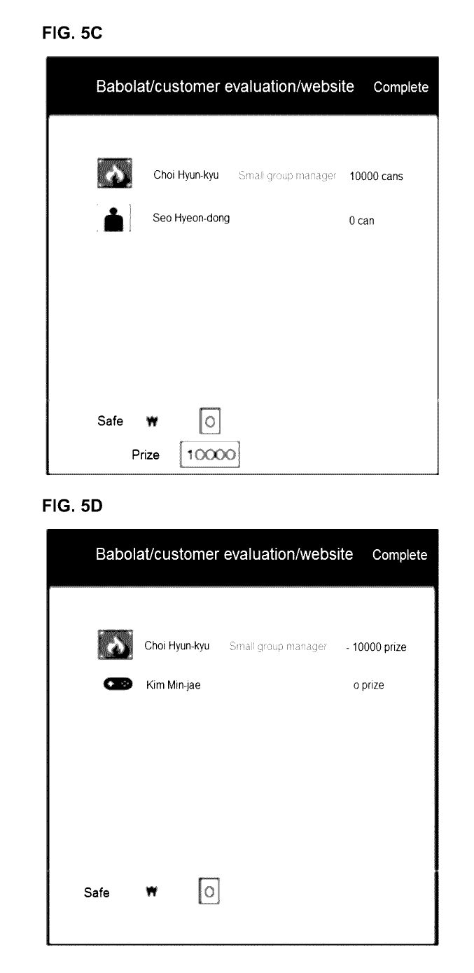

FIGS. 5A-5C are diagrams illustrating the present situations of a group point and group safe in the group or subgroup of FIGS. 3A-3C.

In FIG. 5A, the customer management server 110 includes “Choi Hyun-kyu” and “Seo Hyeon-dong” corresponds to group managers, that is, participants of the main group. “Seo Hyeon-dong” has deposited the Korean won corresponding to 23000 “won” on a group safe and has owned 23 “balls” according to a group point exchange ratio. The customer management server 110 may receive a tennis goods transaction request (i.e., a request to purchase specific tennis goods) of the main group through the owned group point from “Seo Hyeon-dong” who has owned the group point “balls”, and may perform a transaction procedure in response to the tennis goods transaction request.

In FIG. 5B, the customer management server 110 may provide an exchange interface in which the exchange of group points or the exchange of a group point and actual money can be performed in response to a request from a group participant. For example, the exchange interface may include an exchange target group (e.g., the first subgroup), the group point exchange number (10000 “cans”) of the first subgroup, the group point exchange number (10000 “prizes”) of the second subgroup, the present group point situation prior to an exchange (e.g., the group point 0 “can” of the first subgroup and the group point 0 “can” of the second subgroup), and the present group point situation (e.g., the remaining group point amount 10000 “cans” of the first subgroup and the remaining group point amount −10000 “prizes” of the second subgroup) after an exchange. As described above, the customer management server 110 permits an exchange of group points having a minus value because the first subgroup and the second subgroup are set to allow credit transactions.

FIG. 5C is a diagram illustrating the present group point situation and present group safe situation of the first subgroup after group points are exchanged in FIG. 5B. The customer management server 110 may receive an exchange request for the group point of the first subgroup and the group point of the second subgroup from “Choi Hyun-kyu”, that is, a small group manager, may provide 10000 “cans” to “Choi Hyun-kyu”, and may deposit 10000 “prizes”, received from “Choi Hyun-kyu”, to the group safe of the first subgroup.

FIG. 5D is a diagram illustrating the present group point situation and present group safe situation of the second subgroup after the exchange of the group points of FIG. 5B. The customer management server 110 may update the present group point situation and present group safe situation of the second subgroup in response to the exchange request for the group point of the first subgroup and the group point of the second subgroup from “Choi Hyun-kyu.” That is, the customer management server 110 may update the group point of the second subgroup of “Choi Hyun-dong” with −10000 “prizes” in response to the provision of 10000 “prizes” of “Choi Hyun-dong.”

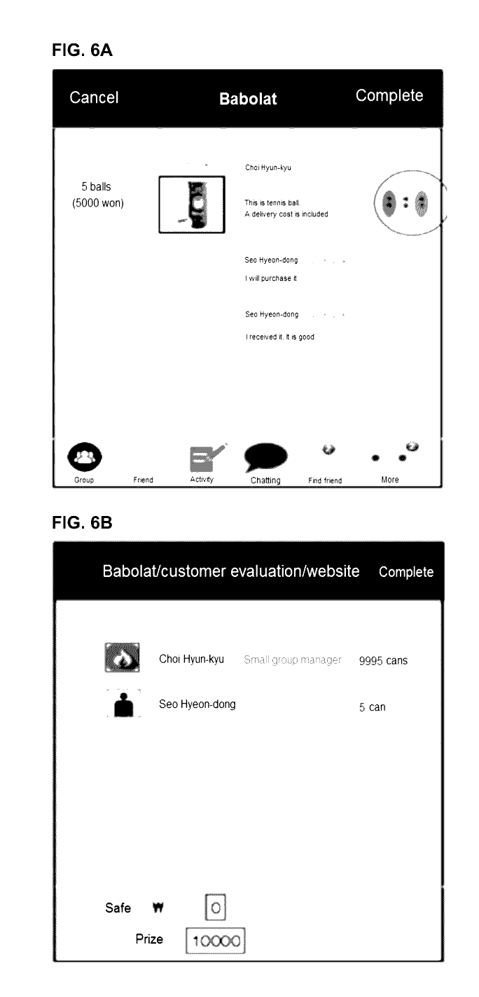

FIGS. 6A and 6B are diagrams illustrating a process of trading commodities within a group and a process of providing an evaluation point.

FIG. 6A is a diagram showing a process of trading commodities in the main group (name “Babolat”) and transaction messages in the process. The customer management server 110 may manage a commodity or service transaction procedure through the group point of the main group in the main group. To this end, the customer management server 110 may manage a message thread associated with a transaction message (e.g., “This is a tennis ball. A delivery cost is included”) for the transaction of a commodity or service in the main group. That is, the customer management server 110 receives a transaction message (including a wanted transaction group point) associated with the transactions of a commodity or service from a group participant who has joined a created main group, and manage the transaction message.

When a transaction request for the transaction message of “Choi Hyun-kyu” is received from “Seo Hyeon-dong”, the customer management server 110 manages a process (including purchase, delivery, and transaction completion) of trading a commodity (“tennis ball”) included in a corresponding transaction message. The customer management server 110 receives 5 “balls” (i.e., a wanted transaction group point, and it corresponds to 5000 “won”, that is, a group point set in the transaction message), corresponding to purchase money, from “Seo Hyeon-dong”, that is, a purchaser in the transaction process of the commodity. When transaction completion is received from the purchaser “Seo Hyeon-dong”, the customer management server 110 may relay the transactions of the commodity by providing 5 “balls”, received from the purchaser, to “Choi Hyun-kyu”, that is, a seller.

FIG. 6B is a diagram illustrating the present situation in which evaluation points are provided between group participants. When transactions between group participants are completed, the customer management server 110 may receive an evaluation point providing request from a group participant corresponding to the seller of a commodity. The evaluation point providing request refers to the seller's request to provide the purchaser of the commodity with the group point (hereinafter referred to as an “evaluation point”) of the first subgroup. When an evaluation point providing request is received from a group participant, the customer management server 110 may provide the purchaser of a commodity with a corresponding requested evaluation point. In FIG. 6B, the customer management server 110 may provide “Seo Hyeon-dong” with an evaluation point corresponding to 5 “cans” in response to an evaluation point providing request from “Choi Hyun-kyu.” In this case, the evaluation point corresponds to the group point of the first subgroup, and may be included in the evaluation message of the first subgroup. In response to the evaluation point provision of the customer management server 110, the group point of the first subgroup of “Choi Hyun-kyu” may become 9995 “cans” and the group point of the first subgroup of “Seo Hyeon-dong” has become 5 “cans.”

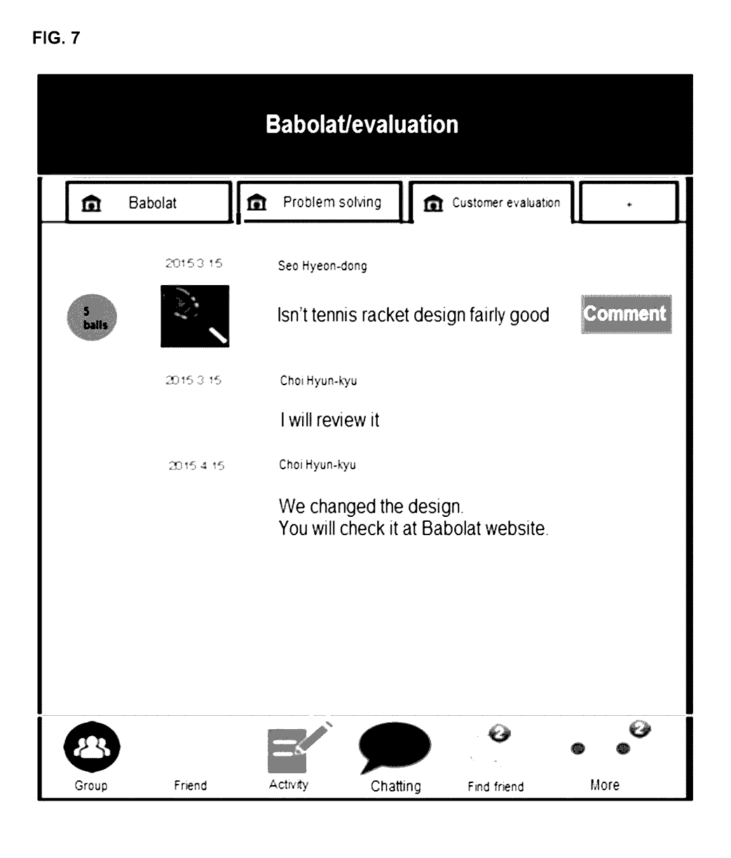

FIG. 7 is a visualized diagram illustrating the evaluation message of a purchaser and a message thread associated with the evaluation message.

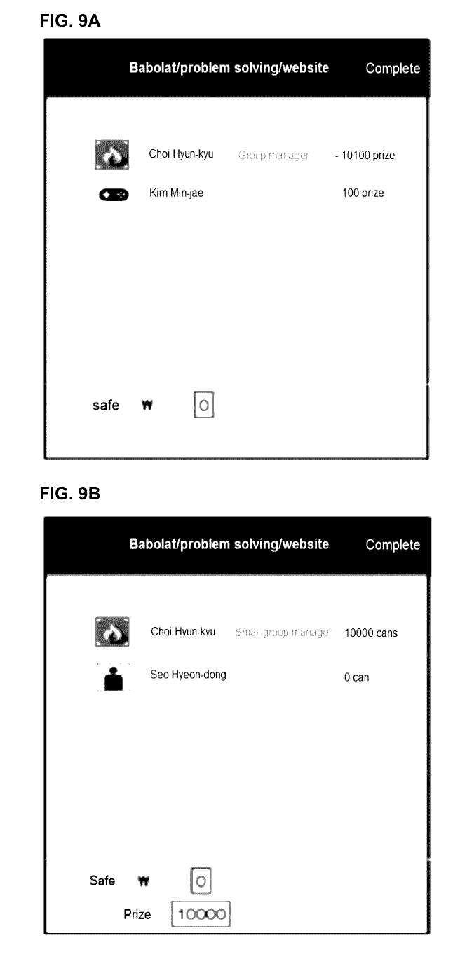

The customer management server 110 may receive the evaluation message of a group participant, may store the received evaluation message in the first subgroup, and may manage the stored evaluation message. The customer management server 110 may include an evaluation point in a corresponding evaluation message in response to the setting of an evaluation message writer. In FIG. 7, the customer management server 110 receives an evaluation message (“Isn't the tennis racket design fairly good”) written by “Seo Hyeon-dong”, and updates the first subgroup with the received evaluation message. In this case, the evaluation message includes an evaluation point of 5 “cans.” Finally, when a response to the evaluation message is received, the customer management server 110 may provide the corresponding evaluation point, included in the evaluation message, to a group participant who has responded to the corresponding evaluation message. A process of providing the evaluation point is described in detail with reference to FIGS. 9A and 9B.

The customer management server 110 may request the group participant who has received the evaluation point to write an evaluation message. In an embodiment, when the evaluation message of a purchaser is not received for a predetermined period, the customer management server 110 may provide a seller with a provided evaluation point. In another embodiment, when the evaluation message of a purchaser is not received for a predetermined period, the customer management server 110 may exchange an evaluation point with another group point and provide the purchaser with the exchanged point.

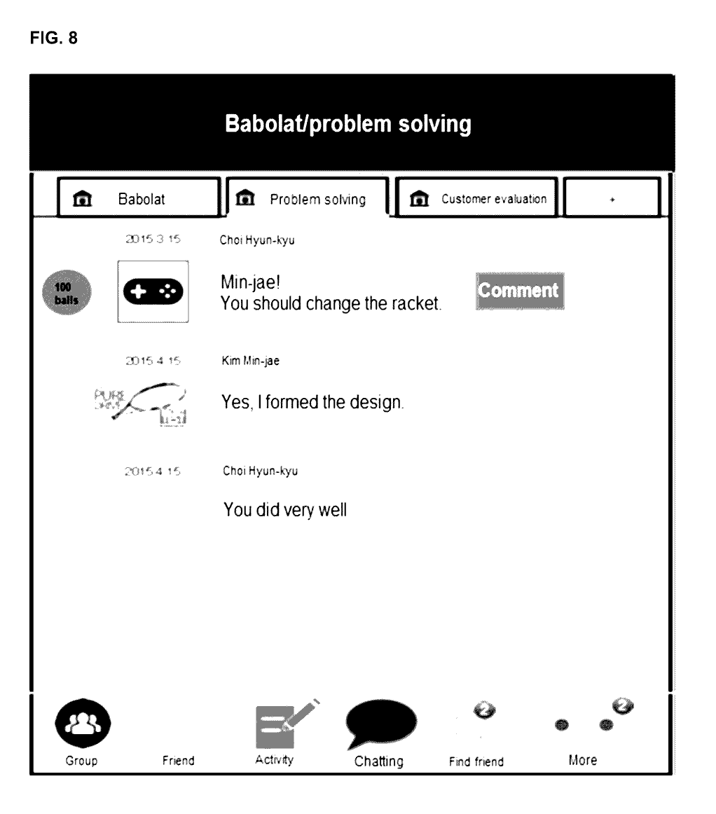

FIG. 8 is a visualized diagram illustrating the problem message of a seller and a message thread associated with the problem message.

The customer management server 110 may receive a problem message from the group participant of a commodity or service, may store the received problem message in the second subgroup, and may manage the stored problem message. The problem message is a message associated with the evaluation message, and corresponds to a message (including the contents of the problem position) for improving evaluation for the commodity or service or a complaint included in the evaluation message. The customer management server 110 may include a problem point in the corresponding problem message in response of the setting of a problem message writer. In FIG. 8, the customer management server 110 receives a problem message (“Min-jae! you should change the racket”) written by “Choi Hyun-kyu” and updates the second subgroup. In this case, the evaluation message includes the problem point of 100 “prizes.” Finally, when a response to the problem message is received, the customer management server 110 may provide the corresponding problem point included in the problem message to a group participant who has responded to the problem message. A process of providing the problem point is described in detail with reference to FIGS. 9A and 9B.

FIGS. 9A and 9B are visualized diagrams illustrating the results of the settlement of the problem point included in the problem message and the evaluation point included in the evaluation message.

First, FIG. 9A is a visualized diagram of the results of the settlement of the problem point in response to the problem message. The customer management server 110 may check whether the writer of the problem message has responded to the problem message. In this case, the response to the problem message may mean whether contents included in the problem message have been achieved. When a completion request (e.g., a request meaning that the contents of the posed problem included in the problem message have been solved) included in the response to the problem message is received from the writer of the problem message, the customer management server 110 may provide a problem point, included in the problem message, to a group participant who is associated with the response to the problem message. The group participant who is associated with the response to the problem message may be set by the writer of the problem message when the problem message is written or may be subsequently changed. In FIG. 9A, the customer management server 110 may provide a corresponding problem point 100 “prizes”, included in the problem message, to “Kim Min-jae” who is associated with the response to the problem message written by “Choi Hyun-kyu.” The customer management server 110 may update the group point −10000 “prizes” of the second subgroup of “Choi Hyun-kyu” with −10100 “prizes” and the group point 0 “prize” of the second subgroup of “Kim Min-jae” with 100 “prizes” by incorporating a process of providing a problem point, and may store them.

In an embodiment, the customer management server 110 may provide a problem point to a group participant who has responded to a problem message on condition that a solution response regarding the evaluation message of the writer of an evaluation message is received.

FIG. 9B is a visualized diagram of the results of the settlement of an evaluation point according to the solution of an evaluation message. The customer management server 110 may check whether the writer of an evaluation message has responded to the solution of the evaluation message. In this case, the response to the solution of the evaluation message may mean whether contents included in the evaluation message have been solved. When a solution response to the evaluation message is received from the writer of the evaluation message, the customer management server 110 may provide an evaluation point, included in the evaluation message, to a group participant who is associated with the response to the corresponding evaluation message. The group participant who is associated with the response to the evaluation message may be set by the writer of the evaluation message when the evaluation message is written or may be subsequently changed. In FIG. 9B, the customer management server 110 may provide a corresponding evaluation point 5 “cans”, included in the evaluation message, to “Choi Hyun-kyu” who is associated with the response to the evaluation message written by “Seo Hyeon-dong.” The customer management server 110 may update the group point 9995 “cans” of the first subgroup of “Choi Hyun-kyu” with 10000 “cans” and the group point 5 “cans” of the first subgroup of “Seo Hyeon-dong” with 0 “cans” by incorporating a process of providing an evaluation point, and may store them.

In an embodiment, when an evaluation response to an evaluation message is received, the customer management server 110 may return (or provide) an evaluation point to a seller and also provide a specific group point to a purchaser in return for the evaluation of the purchaser under the control of the seller.

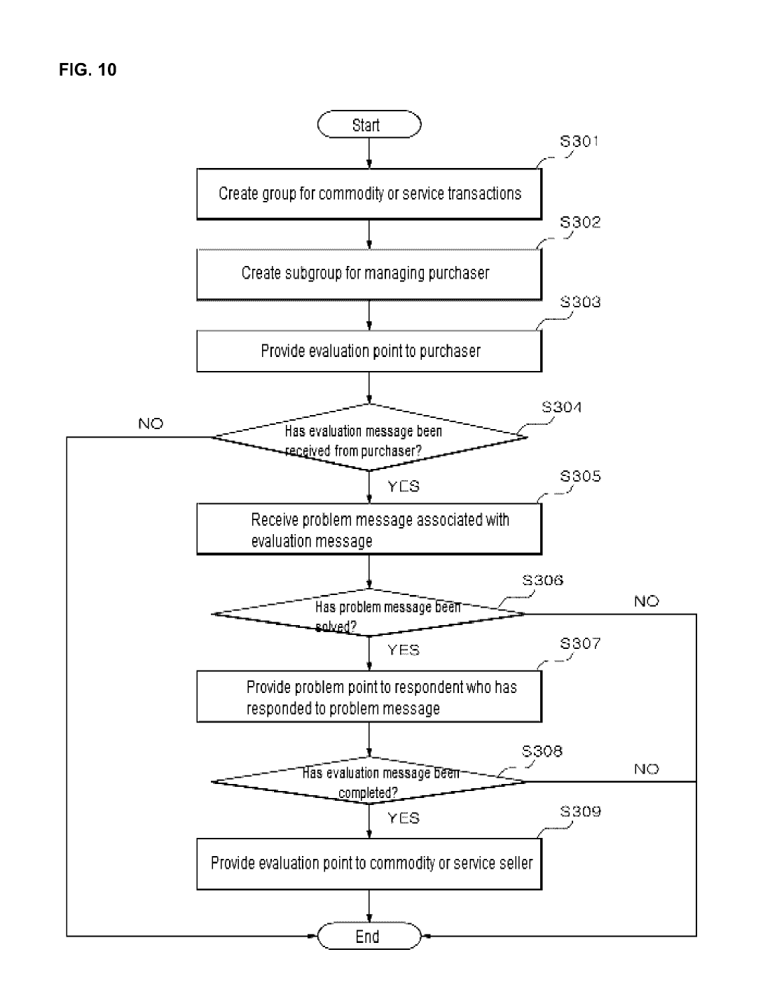

FIG. 10 is a flowchart illustrating a procedure for managing customers within a group, which is performed by the customer management server of FIG. 2.

The customer management server 110 may create a group in which a commodity or service is traded through a group point at step S301. In the process of creating the group in which the commodity or service is traded, the customer management server 110 may create a subgroup in which the purchaser of the commodity or service is managed at step S302. In other words, in order to manage the purchaser of the commodity or service, the customer management server 110 may create a first subgroup in which an evaluation message is stored and a second subgroup in which a problem message is stored.

When the transaction of the commodity or service through the group point is completed, the customer management server 110 may provide an evaluation point to the purchaser of the commodity or service at step S303. At this time, the customer management server 110 may request the purchaser who has received the evaluation point to write an evaluation message.

The customer management server 110 may check whether an evaluation message has been received from the purchaser at step S304. When the evaluation message is received from the purchaser, the customer management server 110 may store the received evaluation message in the first subgroup and manage it.

The customer management server 110 may receive a problem message (it may be associated with the evaluation message) from a group participant who is associated with the transactions of the commodity or service at step S305. The customer management server 110 may store the received problem message in the second subgroup, may manage the stored problem message, and may check whether a response to the stored problem message is received at step S306. When a response to the corresponding problem message is received, the customer management server 110 may provide a problem point included in the problem message to a respondent who has responded to the corresponding problem message at step S307. The customer management server 110 may check whether a response to the evaluation message is received independently of whether a response to the problem message is received or depending on whether a response to the problem message is received at step S308. When a solution response to the evaluation message is received, the customer management server 110 may provide an evaluation point, included in the evaluation message, to a group participant (may correspond to the seller of the commodity or service) who is associated to the response to the evaluation message at step S309.

The disclosed technology may have the following effects. However, it is not meant that a specific embodiment should include all of the following effects or include only the following effects, and thus the range of the right of the disclosed technology should not be construed as being restricted by the description.

The method for managing customers within a group according to an embodiment of the present invention can provide a method for evaluating commodity or service transactions performed within a specific group.

The method for managing customers within a group according to an embodiment of the present invention can manage a complaint of a purchaser regarding the transactions of a commodity or service based on the evaluation message of the purchaser.

The method for managing customers within a group according to an embodiment of the present invention can obtain a corresponding evaluation point in response to the evaluation message of a purchaser by providing an evaluation message including an evaluation point.

The method for managing customers within a group according to an embodiment of the present invention can efficiently handle the evaluation or complaint of a purchaser regarding transactions by providing a problem message associated with the evaluation message of the purchaser.

Although the embodiments of this application have been described above, those skilled in the art will appreciate that the present invention may be modified in various ways without departing from the spirit and scope of the present invention written in the appended claims.

What is claimed is:

1. A computer-executable method for managing customers within a group, comprising steps of:
(a) creating a transaction group in which a seller and a purchaser participate and a commodity or service is traded through a group point dependent on a group;
(b) providing the purchaser with an evaluation participation opportunity by providing the purchaser with an evaluation point when a purchase of the commodity or service is completed;
(c) receiving evaluation for the commodity or service from the purchaser and requesting an evaluation response according to the evaluation from the seller; and
(d) returning the evaluation point to the seller when the evaluation response is received and providing the purchaser with a group point according to the evaluation under a control of the seller.

2. The computer-executable method of claim 1, wherein the step (a) comprises generating a subgroup in which the purchaser is managed.

3. The computer-executable method of claim 2, wherein the step (a) further comprises:
creating a first subgroup and a second subgroup,
receiving evaluation for the commodity or service from the purchaser through the first subgroup, and
receiving a problem posed in association with the evaluation from the seller through the second subgroup.

4. The computer-executable method of claim 3, wherein the step (a) further comprises:
receiving an evaluation message comprising an evaluation point provided by the seller from the seller through the first subgroup, and
receiving a problem message comprising a problem point through the second subgroup.

5. The computer-executable method of claim 2, wherein the step (a) further comprises:
receiving a setting request for a group point or subgroup point dependent on the subgroup, and
setting an exchange ratio of the subgroup point and the group point.

6. The computer-executable method of claim 1, wherein the step (a) comprises receiving a transaction request associated with the transactions of the commodity or service from the seller.

7. The computer-executable method of claim 4, wherein the step (d) comprises providing the problem point included in the problem message to a group participant who has responded to the posed problem when a response to the posed problem is received.

8. The computer-executable method of claim 7, wherein the step (d) further comprises providing the problem point to the group participant who has responded to the posed problem on condition that a solution response regarding the evaluation message is received from the purchaser.

9. The computer-executable method of claim 1, wherein the step (b) comprises:
requesting the purchaser to participate in the evaluation of the commodity or service, and
recovering the evaluation point provided to the purchaser if the evaluation of the purchaser is not received for a predetermined period.

10. The computer-executable method of claim 1, wherein the step (a) comprises:
creating a group or subgroup comprising at least one group participant, and
setting whether the group or subgroup is to be public or not in order for another user to be capable of participating in the group or subgroup.

11. A customer management server within a group, comprising a processor and memory, wherein the processor performs processes of:
(a) creating a transaction group in which a seller and a purchaser participate and a commodity or service is traded through a group point dependent on a group;
(b) providing the purchaser with an evaluation participation opportunity by providing the purchaser with an evaluation point when a purchase of the commodity or service is completed;
(c) receiving evaluation for the commodity or service from the purchaser and requesting an evaluation response according to the evaluation from the seller; and
(d) returning the evaluation point to the seller when the evaluation response is received and providing the purchaser with a group point according to the evaluation under a control of the seller.

12. The customer management server of claim 11, wherein in the process (a), the processor creates a first subgroup in which the purchaser is managed and a second subgroup, receives evaluation for the commodity or service from the purchaser through the first subgroup, and receives a problem posed in association with the evaluation from the seller through the second subgroup.

13. The customer management server of claim 12, wherein in the process (a), the processor receives an evaluation message comprising an evaluation point provided by the seller from the seller through the first subgroup and receives a problem message comprising a problem point through the second subgroup.

14. The customer management server of claim 13, wherein in the process (d), the processor provides the problem point included in the problem message to a group participant who has responded to the posed problem when a response to the posed problem is received.

15. A computer-readable recording medium on which a program for executing a method for managing customers within a group on a computer is recorded, the method comprising functions for:
creating a transaction group in which a seller and a purchaser participate and a commodity or service is traded through a group point dependent on a group;
providing the purchaser with an evaluation participation opportunity by providing the purchaser with an evaluation point when a purchase of the commodity or service is completed;
receiving evaluation for the commodity or service from the purchaser and requesting an evaluation response according to the evaluation from the seller; and
returning the evaluation point to the seller when the evaluation response is received and providing the purchaser with a group point according to the evaluation under a control of the seller.
